(19) United States
(12) Patent Application Publication
(10) Pub. No.: US 2023/0252679 A1
(43) Pub. Date: Aug. 10, 2023

(54) EXTRINSIC PARAMETER CALIBRATION DEVICE AND METHOD FOR MULTIPLE CAMERA DEVICES, STORAGE MEDIUM, AND ELECTRONIC DEVICE

(71) Applicant: Horizon Journey (Hangzhou) Artificial Intelligence Technology Co., Ltd., Zhejiang (CN)

(72) Inventor: Lei YU, Zhejiang (CN)

(73) Assignee: Horizon Journey (Hangzhou) Artificial Intelligence Technology Co., Ltd., Zhejiang (CN)

(21) Appl. No.: 18/003,798

(22) PCT Filed: Jan. 29, 2022
(86) PCT No.: PCT/CN2022/075099

§ 371 Date: Dec. 29, 2022

(30) Foreign Application Priority Data
Jun. 23, 2021 (CN) 202110700660.0

(51) Int. Cl. G06T 7/80

(52) U.S. Cl. CPC G06T 7/80

(57) ABSTRACT

Disposed are an extrinsic parameter calibration device and method for multiple camera devices, a storage medium and electronic device. The device includes: a plurality of mobile calibration plates, configured to calibrate extrinsic parameters of all camera devices carried on a mobile carrier which is disposed in a set space, wherein each mobile calibration plate is disposed on a slide rail disposed on a wall in the set space; and a control device, configured to control each of the mobile calibration plates to slide along the slide rail corresponding to the mobile calibration plate. In this disclosure, extrinsic parameters of camera devices disposed on mobile carrier are simultaneously calibrated by disposing a plurality of mobile calibration plates in the set space, thereby improving anti-noise and anti-interference capabilities of calibration, having strong robustness, effectively improving calibration efficiency and accuracy of calibration result, and also saving costs and time of calibration.

### RELATED APPLICATION INFORMATION

This application claims priority to the Chinese patent Application No. 202110700660.0, filed with the Chinese National Intellectual Property Administration on Jun. 23, 2021 and entitled “EXTRINSIC PARAMETER CALIBRATION DEVICE AND METHOD FOR MULTIPLE CAMERA DEVICES, STORAGE MEDIUM, AND ELECTRONIC DEVICE”, the entire disclosures of which are incorporated by reference in their entirety herein.

### FIELD OF THE INVENTION

The present disclosure relates to the technical field of extrinsic parameter calibration, and in particular, to an extrinsic parameter calibration device and method for multiple camera devices, a storage medium, and an electronic device.

### BACKGROUND OF THE INVENTION

Traffic safety has always been one of the important issues that people are concerned about. A lot of traffic accidents occur every year on expressways, resulting in serious casualties and great economic losses. Therefore, it is significant to develop an advanced driver assistance system. A camera module serves as an eye of the driver assistance system, and is configured to measure an external surrounding environment and make driving judgments based on the external surrounding environment. During an image measurement process, to determine a relationship between a three-dimensional geometric position of a point on a surface of a spatial object and a corresponding point in an image, geometric models for camera imaging need to be established. Model parameters of these geometric models can be used as camera parameters.

Under most conditions, camera parameters can be obtained merely through experiments and calculations, and a process of solving the parameters is referred to as camera calibration. Camera calibration is a very critical link in both image measurement and machine vision applications. Accuracy of a calibration result and algorithm stability of the camera calibration directly affect accuracy of a result generated during work of the camera. Therefore, camera calibration is premise for subsequent work, and improving calibration accuracy is focus of scientific research.

### SUMMARY OF THE INVENTION

To resolve the foregoing technical problem, the present disclosure is proposed. Embodiments of the present disclosure provide an extrinsic parameter calibration device and method for multiple camera devices, a storage medium, and an electronic device.

According to an aspect of the embodiments of the present disclosure, the present disclosure provides an extrinsic parameter calibration device for multiple camera devices, including:

a plurality of mobile calibration plates, configured to complete extrinsic parameter calibration of all of the multiple camera devices carried on a mobile carrier that is disposed in a set space, wherein each mobile calibration plate is disposed on a slide rail which is disposed on a wall in the set space; and a control device, configured to control each of the mobile calibration plates to slide along the slide rail corresponding to the mobile calibration plate.

According to another aspect of the embodiments of the present disclosure, the present disclosure provides an extrinsic parameter calibration method for multiple camera devices, including:

in response to a mobile carrier, that carries the multiple camera devices, entering a set space, controlling a plurality of mobile calibration plates in the set space to move to a position corresponding to each of the multiple camera devices; and performing extrinsic parameter calibration on the multiple camera devices based on the plurality of mobile calibration plates.

According to another aspect of the embodiments of the present disclosure, the present disclosure provides an extrinsic parameter calibration method for multiple camera devices, including:

performing image acquisition on a calibration plate corresponding to each of the multiple camera devices that are disposed on a mobile carrier, to obtain a plurality of images, wherein each camera device corresponds to one image; and determining target extrinsic parameter information of each of the multiple camera devices based on each of the plurality of images and intrinsic parameter information of each of the multiple camera devices.

According to still another aspect of the embodiments of the present disclosure, the present disclosure provides a computer readable storage medium, wherein the storage medium stores a computer program, and the computer program is used for implementing the extrinsic parameter calibration method for multiple camera devices according to any one of the foregoing embodiments.

According to yet another aspect of the embodiments of the present disclosure, the present disclosure provides an electronic device, wherein the electronic device includes:

a processor; and a memory, configured to store processor-executable instructions,

wherein the processor is configured to read the executable instructions from the memory, and execute the instructions to implement the extrinsic parameter calibration method for multiple camera devices according to any one of the foregoing embodiments.

Based on the extrinsic parameter calibration device and method for multiple camera devices, the storage medium, and the electronic device that are provided in the foregoing embodiments of the present disclosure, through disposing a plurality of mobile calibration plates in a set space, extrinsic parameter calibration is simultaneously performed on a plurality of camera devices that are disposed on the mobile carrier, thereby improving anti-noise and anti-interference capabilities of the extrinsic parameter calibration, achieving strong robustness, effectively improving accuracy of a calibration result and calibration efficiency, and also saving costs and time of calibration.

### BRIEF DESCRIPTION OF THE DRAWINGS

By describing the embodiments of the present disclosure more detailed with reference to the accompanying drawings, the foregoing and other objectives, features, and advantages of the present disclosure will become more apparent. The accompanying drawings are used to provide further understanding of the embodiments of the present disclosure, and constitute a part of the specification, explaining the present disclosure together with the embodiments of the present disclosure, but not constituting limitation to the present disclosure. In the accompanying drawings, the same reference numerals generally represent the same components or steps.

FIG. 1a is a schematic scenario diagram of a mass-production calibration field to which the present disclosure is applicable;

FIG. 1b is a top view of the mass-production calibration field shown in FIG. 1a;

FIG. 2 is a schematic structural diagram of a mechanical movable limiting guide in a mass-production calibration field to which the present disclosure is applicable;

FIG. 3 is a schematic structural diagram of an extrinsic parameter calibration device for multiple camera devices according to an exemplary embodiment of the present disclosure;

FIG. 4 is a schematic flowchart of an extrinsic parameter calibration method for multiple camera devices according to an exemplary embodiment of the present disclosure;

FIG. 5 is a schematic flowchart of an extrinsic parameter calibration method for multiple camera devices according to another exemplary embodiment of the present disclosure;

FIG. 6 is a schematic flowchart of Step 502 in the embodiment shown in FIG. 5 according to the present disclosure; and

FIG. 7 is a structural diagram of an electronic device according to an exemplary embodiment of the present disclosure.

### DETAILED DESCRIPTION OF THE EMBODIMENTS

Exemplary embodiments of the present disclosure are described below in detail with reference to the accompanying drawings. Obviously, the described embodiments are merely a part, rather than all of embodiments of the present disclosure. It should be understood that the present disclosure is not limited by the exemplary embodiments described herein.

It should be noted that unless otherwise specified, the scope of the present disclosure is not limited by relative arrangement, numeric expressions, and numerical values of components and steps described in these embodiments.

A person skilled in the art may understand that terms such as “first” and “second” in the embodiments of the present disclosure are merely configured to distinguish between different steps, devices, or modules, and indicate neither any particular technical meaning, nor necessarily logical ordering among them.

It should be further understood that, in the embodiments of the present disclosure, the term “multiple”/“a plurality of” may refer to two or more; and the term “at least one” may refer to one, two, or more.

It should be further understood that any component, data, or structure involved in the embodiments of the present disclosure can be generally construed to one or more, unless clearly stated or the context indicates otherwise.

In addition, the term “and/or” in the present disclosure refers to only an association relationship that describes associated objects, indicating presence of three relationships. For example, A and/or B may indicate presence of three cases: A alone, both A and B, and B alone. In addition, the character “/” in the present disclosure generally indicates an “or” relationship of associated objects.

It should be further understood that the descriptions of the various embodiments of the present disclosure focus on differences among the various embodiments. The same or similar parts among the embodiments may refer to one another, and for concision, descriptions thereof are not repeated.

Meanwhile, it should be understood that, for ease of description, the accompanying drawings are not necessarily to scale in size of any of parts shown therein.

Descriptions of at least one exemplary embodiment below are actually illustrative only, and never serve as any limitation to the present disclosure along with application or use thereof.

Technologies, methods, and devices known by a person of ordinary skills in the art may not be discussed in detail herein. However, where appropriate, the technologies, the methods, and the devices shall be regarded as a part of the specification.

It should be noted that, similar signs and letters in the following accompanying drawings indicate similar items. Therefore, once a certain item is defined in one of the accompanying drawings, there is no need to further discuss the item in the subsequent accompanying drawings.

The embodiments of the present disclosure can be applicable to a terminal device, a computer system, a server, and other electronic devices, which can be operated together with numerous other general-purpose or special-purpose computing system environments or configurations. Well-known examples of the terminal device, the computing system, and environment and/or configuration applicable to be used with the terminal device, the computer system, the server, and other electronic devices include but are not limited to: a personal computer system, a server computer system, a thin client, a thick client, a handheld or laptop device, a microprocessor-based system, a set-top box, programmable consumer electronics, a network personal computer, a small computer system, a mainframe computer system, and a distributed cloud computing technology environment including any of the foregoing systems.

The terminal device, the computer system, the server, and other electronic devices may be described in general context of computer system-executable instructions (such as a program module) executed by the computer system. Generally, the program module may include a routine, a program, a target program, a component, logic, a data structure, and the like that execute particular tasks or implement particular abstract data types. The computer system/server may be implemented in a distributed cloud computing environment. In the distributed cloud computing environment, a task is performed by a remote processing device linked through a communications network. In the distributed cloud computing environment, the program module can be located on a storage medium of a local or remote computing system including a storage device.

Application Overview

In a process of implementing the present disclosure, the applicant finds that a common calibration method in the prior art has at least the following problems: the complicated process, incompetent anti-noise and anti-interference capabilities, and low calibration efficiency.

Exemplary System

A static calibration method needs to use a calibration object with a known size to obtain intrinsic and extrinsic parameters of a camera model by using a certain algorithm through establishing a correspondence between a coordinate point of the calibration object and an image point of the calibration object. Different calibration objects can be classified into three-dimensional calibration objects and planar calibration objects. The three-dimensional calibration object can be calibrated by using a single image, where calibration accuracy is relatively high. Most of the three-dimensional calibration objects are suitable for use in mass-production calibration of a camera module from a vehicle factory.

A static calibration field for mass production can improve reliability and accuracy of a calibration result, thereby greatly shortening time costs of calibration.

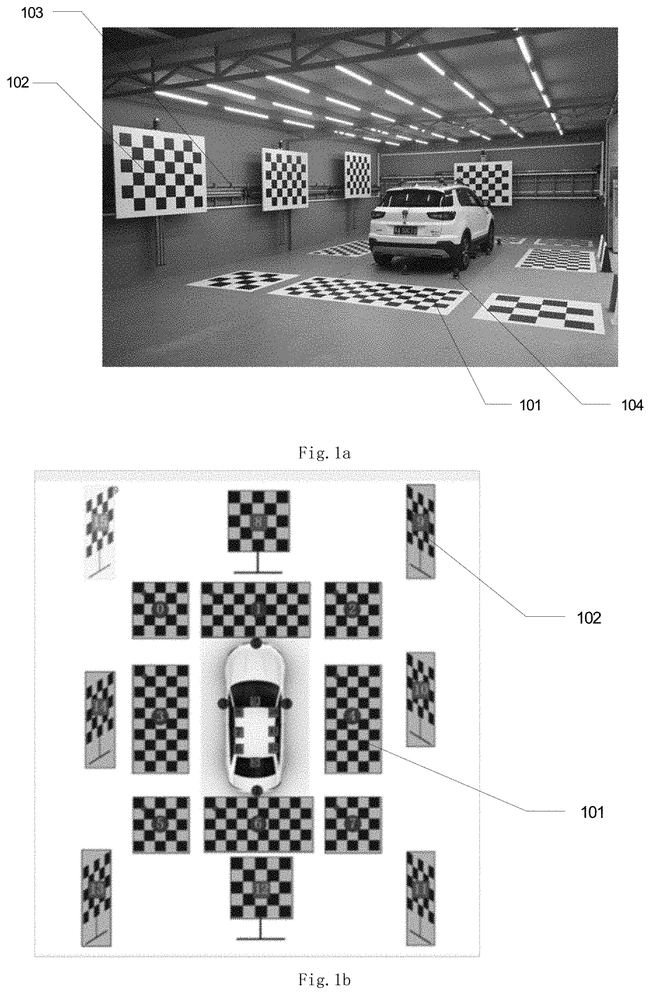

FIG. 1a is a schematic scenario diagram of a mass-production calibration field to which the present disclosure is applicable. In this embodiment, the specification of a fixed calibration field is calculated based on a vehicle model for mass production, and 2D ground checkerboards (fixed calibration plates) 101 and 3D wall checkerboards (mobile calibration plates) 102 are respectively arranged. FIG. 1b is a top view of the mass-production calibration field shown in FIG. 1a. In this top view, distribution of the 2D checkerboard 101 and the 3D wall checkerboard 102 in the mass-production calibration field can be understood more intuitively.

The calibration field can be adapted to different vehicle models, and different camera mounting schemes are used for a vehicle-mounted camera module for calibration.

The 3D wall checkerboard 102 is disposed on a PLC-controlled slide rail 103. As required, by using a controller, the 3D wall checkerboard 102 can be translated upward, downward, leftward, and rightward to a visual range of the camera module for calibration.

The 3D wall checkerboard 102 has relatively high movement precision. For example, the movement precision is 0.1 mm, which can implement a control behavior such as jogging or long pressing or parameter setting of the controller.

The 3D wall checkerboard 102 can implement a function of one-key automatic zero return. In addition, the checkerboard 102 can be moved to a designated position by performing parameter reading according to a set parameter. A calibration field controller can implement functions such as parameter writing, reading, deleting, and saving.

Each 3D wall checkerboard 102 has a power-off self-locking function, to prevent the 3D wall checkerboard 102 from slipping.

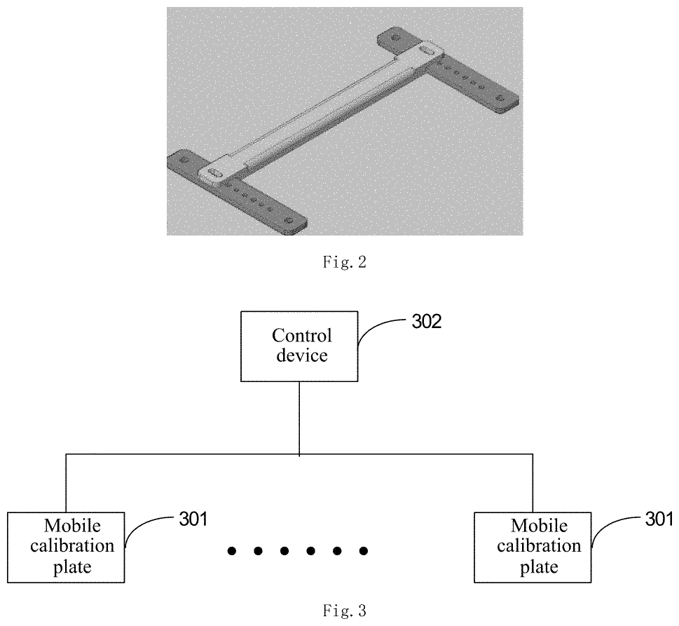

A mechanical movable limiting guide 104 is disposed on the ground in the calibration field. In an optional embodiment, FIG. 2 is a schematic structural diagram of a mechanical movable limiting guide in a mass-production calibration field to which the present disclosure is applicable. As shown in FIG. 2, a width of the mechanical movable limiting guide is adjusted according to tire specification of different vehicle models, so as to limit a position of a vehicle in the calibration field, thereby controlling a distance between locations of a camera module disposed on the vehicle and a calibration plate. The calibration board may include at least one or more of the 2D checkerboard 101 and the 3D wall checkerboard 102.

According to the embodiments of the present disclosure, the position of the vehicle in the calibration field is defined based on the mechanical movable limiting guide. The position of the vehicle in the calibration field can be accurately determined through a position of the mechanical movable limiting guide, so as to obtain a distance between positions of a target calibration plate and the camera module, thereby improving accuracy of a calibration result and saving time and costs of calibration.

Exemplary Device

FIG. 3 is a schematic structural diagram of an extrinsic parameter calibration device for multiple camera devices according to an exemplary embodiment of the present disclosure. As shown in FIG. 3, the device provided in this embodiment includes a plurality of mobile calibration plates 301 and a control device 302.

The plurality of mobile calibration plates 301 are configured to complete extrinsic parameter calibration on all of the multiple camera devices on a mobile carrier that is disposed in a set space and that carries the multiple camera devices.

Each mobile calibration plate is respectively disposed on a slide rail, and the slide rail is disposed on a wall in the set space.

Optionally, the mobile calibration plate in this embodiment may be understood with reference to the 3D wall checkerboard 102 in the embodiment shown in FIG. 1a, and the slide rail in this embodiment may be understood with reference to the PLC-controlled slide rail 103 in the embodiment shown in FIG. 1a. Certainly, in actual application, information such as a size, a shape, and an internal division size of the mobile calibration plate can be freely set according to specific application scenarios. For example, information such as directions and quantity of slide rails is included. Moreover, processes of setting the information are not limited in the embodiment provided in FIG. 1a.

The control device 302 is configured to control each of the plurality of mobile calibration plates 301 to slide along the slide rail corresponding to the mobile calibration plate 301.

The control device 302 in this embodiment may be any controller, for implementing a control behavior such as jogging, long pressing, or parameter setting for the plurality of mobile calibration plates 301. According to this embodiment, accuracy of a calibration result of performing extrinsic parameter calibration on the camera devices is improved through high-accuracy position control of the control device 302.

This embodiment provides an extrinsic parameter calibration device for multiple camera devices. Through disposing a plurality of mobile calibration plates in a set space, extrinsic parameter calibration is simultaneously performed on a plurality of camera devices that are disposed on the mobile carrier; and in this embodiment, the extrinsic parameter calibration is completed in the set space, and interference such as noise generated in the outside world is greatly reduced. Therefore, anti-noise and anti-interference capabilities of the extrinsic parameter calibration are improved, robustness is relatively strong, accuracy of a calibration result is effectively improved, calibration efficiency is improved, and costs and time of calibration are both saved.

In some optional embodiments, the control device 302 is further configured to control slide between a plurality of slide rails that have a connection relationship, so as to control the mobile calibration plate 301 to slide in various directions such as upward, downward, leftward, and rightward on a plane corresponding to the wall where the mobile calibration plate 301 is located.

In this embodiment, with reference to the embodiment shown in FIG. 1a, the 3D wall checkerboard 102 is disposed on the wall through a vertical slide rail. Moreover, the 3D wall checkerboard 102 slides on the vertical slide rail, so that the mobile calibration plate moves in a y-axis direction (moves upward and downward) in a coordinate system of a plane where the wall is located.

Optionally, the vertical slide rail is movably connected to a transverse slide rail that is horizontally disposed. The vertical slide rail slides on the transverse slide rail, so that the mobile calibration plate 301 moves on an x-axis (moves leftward and rightward) in the coordinate system of the plane where the wall is located. According to this embodiment, through disposing of the transverse slide rail and the vertical slide rail, the mobile calibration plate 301 slides arbitrarily in various directions on a plane corresponding to the wall where the mobile calibration plate 301 is located, thereby improving accuracy of the extrinsic parameter calibration.

Optionally, according to control of the control device 302, the mobile calibration plate 301 may slide in at least one moving mode as follows. Said at least one moving mode includes set-unit movement, set-length movement, or continuous movement.

In addition, a regression button is further provided on the control device 302, and the plurality of mobile calibration plates 301 may be regressed to an initial position through control of the regression button.

In this embodiment, a value of a set unit may be set according to actual scenarios, and a smaller set unit indicates higher movement accuracy that can be achieved. For example, the set unit is 1 mm, and a movement in a small distance with high accuracy is implemented through the set-unit movement. However, when a large movement is required, the set-unit movement may cause a speed to be slowed down. Therefore, this embodiment also provides methods of set-length movement and continuous movement.

The set-length movement may be set based on a moving distance, in any direction described above, of the mobile calibration plate 301 that is directly disposed in the control device. The mobile calibration plate 301 is directly moved to a corresponding position based on a disposed motor. When the corresponding position is not accurate, fine adjustment may be performed in combination with the set-unit movement. By means of the continuous movement, through operations such as long pressing of the control device, a designated mobile calibration plate is controlled to move continuously in a designated direction until a designated position is arrived. When there is a small deviation between the arrived position and a target position, fine adjustment may also be performed by using the set-unit movement.

According to this embodiment, the control device is further provided with the regression button. The regression button is configured to control one-key regression of all mobile calibration plates 301, so that when the mobile calibration plate needs to be moved again, the mobile calibration plate may be moved from the initial position, thereby improving movement accuracy and efficiency.

Optionally, each mobile calibration plate 301 is provided with a locking device for locking a position of a chessboard calibration plate when power is off.

The locking device provided in this embodiment implements a power-off self-locking function of the mobile calibration plate, thereby effectively avoiding a problem that the mobile calibration plate slips due to sudden power failure during use of the slide. Thus, the safety of the device is improved.

In some optional embodiments, a size of the set space is set based on a size of the mobile carrier.

The set space in this embodiment may be understood with reference to the calibration field shown in FIG. 1a. The set space may be used to accommodate the mobile carrier, such as a vehicle, and to perform the extrinsic parameter calibration on the plurality of camera devices that are disposed on the mobile carrier. There is a matching relationship between the size of the set space and the size of the mobile carrier, such as the matching relationship between the calibration field and the vehicle in the calibration field in the embodiment shown in FIG. 1a.

In some optional embodiments, the device provided in this embodiment also includes a limiting guide. The limiting guide may be disposed on the ground of the set space, and a width of the limiting guide is set according to the mobile carrier, so as to limit a position of the mobile carrier in the set space.

In this embodiment, the position of the mobile carrier in the set space is defined by using the limiting guide.

Optionally, with reference to the embodiment shown in FIG. 1a, a function of the mechanical movable limiting guide 104 disposed on the ground in the calibration field for the limiting guide is shown. For a structure of the limiting guide, reference may be made to the embodiment shown in FIG. 2. Various mobile carriers are fixed by using the limiting guide with an adjustable width, which increases a use scope of the device.

In some optional embodiments, the device provided in this embodiment also includes a plurality of fixed calibration plates. The plurality of fixed calibration plates are disposed on the ground of the set space, and are disposed around the limiting guide in the set space.

The plurality of fixed calibration plates in this embodiment may be understood with reference to the 2D checkerboard 101 disposed on the ground in the embodiment shown in FIG. 1a. Moreover, distribution of the fixed calibration plates may be understood from the top view shown in FIG. 1b. The fixed calibration plates are distributed around the limiting guide, and therefore are disposed around the mobile carrier, so as to perform the extrinsic parameter calibration on the camera devices that are on the mobile carrier and that may collect a ground image. In this case, the extrinsic parameter calibration is performed on the camera devices on the mobile carrier in a plurality of directions at the same time.

Exemplary Method

FIG. 4 is a schematic flowchart of an extrinsic parameter calibration method for multiple camera devices according to an exemplary embodiment of the present disclosure. The method provided in this embodiment may be applied to an electronic device. As shown in FIG. 4, the method includes the following steps.

At Step 401, detecting entrance of a mobile carrier that carries a plurality of camera devices into a set space.

In this embodiment, the mobile carrier may be a movable carrier such as a vehicle that can be provided with a plurality of camera devices, and the set space may be the calibration field provided in the embodiment shown in FIG. 1a.

At Step 402, a plurality of mobile calibration plates in the set space are controlled to move to a position corresponding to each of the plurality of camera devices.

In an embodiment, a position of each camera device on the mobile carrier is fixed, and after a position of the mobile carrier is fixed, a corresponding position of each camera device in the set space is determined; however, a control device is configured to control each of the plurality of mobile calibration plates, so that each mobile calibration plate corresponds to one camera device.

At Step 403, extrinsic parameter calibration is performed on the plurality of camera devices based on the plurality of mobile calibration plates.

Specifically, extrinsic parameters of the camera device may include a coordinate position of the camera device in space and pose information of the camera device. The coordinate position is a coordinate of an x-axis, a y-axis, and a z-axis in a calibration coordinate system; and the pose information may include: a pitch angle, a yaw angle, a roll angle, and the like. The calibration coordinate system may be a world coordinate system, or may be a coordinate system taking any point as an origin point; for example, the camera device is taken as an origin point.

This embodiment provides an extrinsic parameter calibration method for multiple camera devices. Through disposing a plurality of mobile calibration plates in the set space, the extrinsic parameter calibration is simultaneously performed on a plurality of camera devices that are disposed on the mobile carrier. Moreover, the extrinsic parameter calibration is completed in the set space, and interference such as noise generated in the outside world is greatly reduced. In this case, anti-noise and anti-interference capabilities of the extrinsic parameter calibration are improved, and there is relatively strong robustness. Moreover, accuracy of a calibration result and calibration efficiency are effectively improved, and costs and time of calibration are both saved.

Optionally, on the basis of the foregoing embodiment, Step 402 may include:

controlling each of the plurality of mobile calibration plates to slide on at least one slide rail, to move the mobile calibration plate to the position corresponding to each camera device in the plurality of camera devices.

In this embodiment, for a relationship between the mobile calibration plate and the slide rail, reference may be made to a relationship between the 3D wall checkerboard 102 and the PLC-controlled slide rail 103 in the embodiment provided in FIG. 1a. Each mobile calibration plate is respectively disposed on the slide rail, and the slide rail is disposed on a wall in the set space. The 3D wall checkerboard 102 slides on the vertical slide rail, so that the mobile calibration plate moves on a y-axis (moves upward and downward) in a coordinate system of a plane where the wall is located.

Optionally, the vertical slide rail is movably connected to a transverse slide rail that is horizontally disposed. The vertical slide rail slides on the transverse slide rail, so that the mobile calibration plate moves on an x-axis (moves leftward and rightward) in the coordinate system of the plane where the wall is located. According to this embodiment, through disposing of the transverse slide rail and the vertical slide rail, the mobile calibration plate 301 slides arbitrarily in various directions such as upward, downward, leftward, and rightward on a plane corresponding to the wall where the mobile calibration plate 301 is located, thereby improving accuracy of the extrinsic parameter calibration.

Optionally, controlling each of the plurality of mobile calibration plates to slide on a plurality of slide rails includes: controlling each of the plurality of mobile calibration plates to slide on a plurality of slide rails according to at least one moving mode, wherein the at least one moving mode includes set-unit movement, set-length movement, and continuous movement.

In this embodiment, a value of a set unit may be set according to actual scenarios, and a smaller set unit indicates higher movement accuracy that can be achieved. For example, the set unit is 1 mm, and a movement in a small distance with high accuracy is implemented through the set-unit movement. However, when a large movement is required, the set-unit movement may cause a speed to be slowed down. Therefore, this embodiment also provides a method of set-length movement and a method of continuous movement.

Set-length movement can be set based on a moving distance in any direction of the mobile calibration plate 301 that is directly disposed in the control device. The mobile calibration plate 301 is directly moved to a corresponding position based on a disposed motor. When the corresponding position is not accurate, fine adjustment may be performed in combination with the set-unit movement. By means of the continuous movement, through operations such as long pressing of the control device, a designated mobile calibration plate is controlled to move continuously in a designated direction until a designated position is arrived. When there is a small deviation between the arrived position and a target position, fine adjustment can also be performed by using the set-unit movement.

Optionally, the method provided in this embodiment further includes: in response to completing the extrinsic parameter calibration on the plurality of camera devices, returning the plurality of mobile calibration plates to an initial position along the slide rail.

Optionally, the process in which each mobile calibration plate returns to the initial position may include: determining a moving distance of the mobile calibration plate in at least one direction based on a distance between a coordinate of a current position of the mobile calibration plate and a coordinate of the initial position; and returning the mobile calibration plate to the initial position based on the moving distance in at least one direction. According to this embodiment, one-key regression of all mobile calibration plates can be controlled by using the regression button, so that when the mobile calibration plate needs to be moved again, the mobile calibration plate can be moved from the initial position, thereby improving movement accuracy and efficiency.

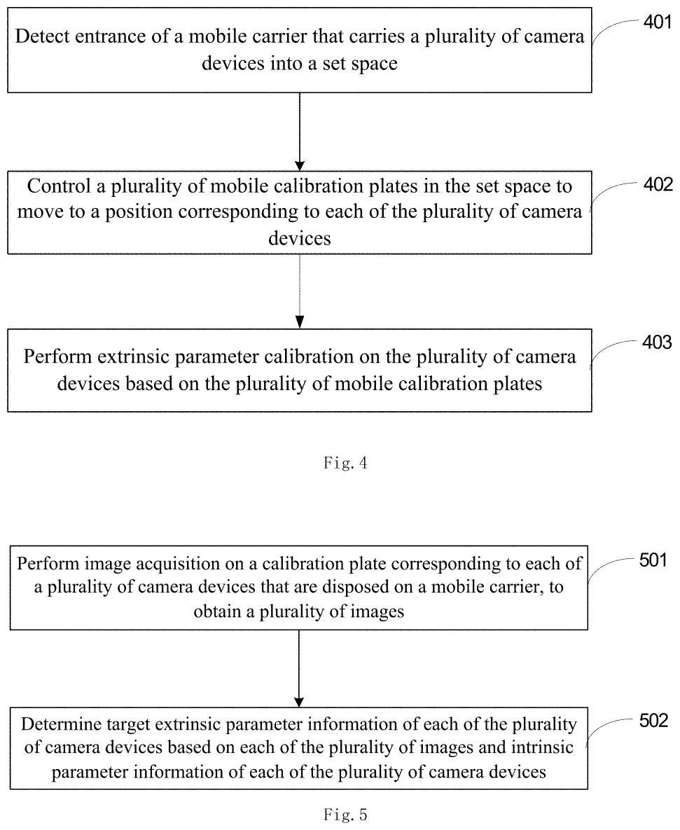

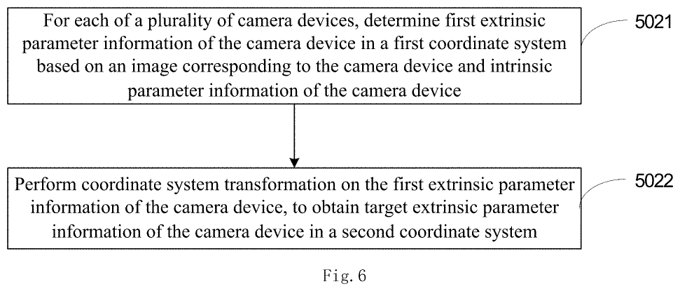

FIG. 5 is a schematic flowchart of an extrinsic parameter calibration method for multiple camera devices according to another exemplary embodiment of the present disclosure. The method may be applied to an electronic device. As shown in FIG. 5, the method includes the following steps.

At Step 501, each of a plurality of camera devices that are disposed on a mobile carrier acquires an image of a calibration plate corresponding to the camera device, to obtain a plurality of images.

Each camera device corresponds to a calibration board, and acquires an image of each calibration board. Therefore, the plurality of camera devices correspondingly acquire a plurality of images.

Optionally, each camera device in this embodiment corresponds to at least one calibration plate, and the calibration plate may include a mobile calibration plate and/or a fixed calibration plate. The camera device may include but is not limited to an ordinary camera, a fisheye camera, or a 3D camera. Any device that can implement an image acquisition function falls within the scope of the camera device described in the present disclosure.

At Step 502, target extrinsic parameter information of each camera device in the plurality of camera devices is determined based on each image in the plurality of images and intrinsic parameter information of each camera device in the plurality of camera devices.

The intrinsic parameter information of the camera device includes a distortion value, a center point, a focal length, and other information of the camera device. The intrinsic parameter information is inherent to each camera device, is fixed when the device is delivered, and is known information of each camera device. In this embodiment, the target extrinsic parameter information of the camera device can be determined through a correspondence relationship between an image coordinate in the acquired image and a coordinate in a real space.

According to the extrinsic parameter calibration method for multiple camera devices provided in this embodiment of the present disclosure, through performing image acquisition and calibration at the same time by using a plurality of camera devices, extrinsic parameter calibration is performed on a plurality of camera devices on the mobile carrier at the same time, and mass-production calibration is implemented for the same mobile carrier (for example, a vehicle). The method has relatively strong applicability and can be applied to various different mobile carriers for mass-production calibration, thereby effectively improving accuracy of a calibration result and improving calibration efficiency. For example, extrinsic parameter calibration is performed on four fisheye surround-view camera modules at one time, to form surround-view splicing. Calibration plates of the four fisheye surround-view camera modules are located at the ground (the 2D checkerboard shown in FIG. 1a), and a size of a site is determined based on a vehicle model for mass production. In addition, extrinsic parameter calibration can also be performed on eight fisheye narrow-angle camera modules at one time.

As shown in FIG. 6, on the basis of the foregoing embodiment shown in FIG. 5, step 502 may include the following steps.

At Step 5021, for each of the plurality of camera devices, first extrinsic parameter information of the camera device in a first coordinate system is determined based on the image corresponding to the camera device and the intrinsic parameter information of the camera device.

In this embodiment, the first extrinsic parameter information of the camera device in the first coordinate system can be determined based on a correspondence relationship between a coordinate of a point in the acquired image in the world coordinate system and a pixel coordinate of the point in the image, and the intrinsic parameter information of the camera device that acquires the image. The first coordinate system may be a coordinate system with the camera device as an origin point.

At Step 5022, coordinate system transformation is performed on the first extrinsic parameter information of the camera device, to obtain the target extrinsic parameter information of the camera device in a second coordinate system.

In this embodiment, when the first coordinate system is a device coordinate system corresponding to each camera device, multiple groups of obtained first extrinsic parameter information are different because the coordinate systems are different. Therefore, an overall relationship of the camera module cannot be determined. To overcome this problem, the first extrinsic parameter information corresponding to each camera device is converted from the first coordinate system corresponding to each camera device to the second coordinate system corresponding to all camera devices, wherein the second coordinate system is a coordinate system of the camera device. In this case, extrinsic parameter information of all camera devices is in a same coordinate system, so as to implement overall calibration on extrinsic parameter information of the camera module disposed on the mobile carrier.

In some optional embodiments, the plurality of camera devices include a plurality of first camera devices and a plurality of second camera devices, and the calibration plates include fixed calibration plates and mobile calibration plates. A first image acquired by each first camera device corresponds to a plurality of fixed calibration plates, and a second image acquired by each second camera device corresponds to one mobile calibration plate.

Step 5021 in the foregoing embodiment may include: determining the first extrinsic parameter information of the first camera device in the first coordinate system based on the first image and the intrinsic parameter information of the first camera device; and determining the first extrinsic parameter information of the second camera device in the first coordinate system based on the second image and the intrinsic parameter information of the second camera device.

Optionally, two types of camera devices are included in this embodiment, such as a first camera device and a second camera device. Further, the first camera device is a fisheye camera, and the second camera device is an ordinary camera. Different camera devices may correspond to different types of calibration plates, wherein the fisheye camera may correspond to the fixed calibration plate, and the ordinary camera corresponds to the mobile calibration plate. Images acquired by different types of cameras may be different. For example, an angle of view of the fisheye camera is relatively large, and is generally up to 220° or 230°, which creates conditions for shooting a large-scale scene at close range. A fisheye lens can create a very strong perspective effect when shooting in a case of being close to an object to be shot, to emphasize a contrast that the shot object is big when near and small when far, so that the shot image is extremely appealing. The fisheye lens has a fairly long depth of field, which is helpful for expressing a long depth of field effect of a picture.

According to this embodiment, different types of calibration plates are provided for different types of cameras, so as to improve accuracy of the obtained first extrinsic parameter information.

Optionally, in the foregoing embodiment, determining the first extrinsic parameter information of the first camera device in the first coordinate system based on the first image and the intrinsic parameter information of the first camera device includes: determining a mapping relationship between a first set point in the fixed calibration plate in the world coordinate system and the first set point in an image coordinate system corresponding to the first image based on an overlapping area between images corresponding to each pair of first camera devices in the plurality of first camera devices and the intrinsic parameter information of each first camera device.

Each pair of first camera devices is two adjacent first camera devices.

For example, when the mobile carrier is a vehicle and the first camera device is a fisheye camera, four fisheye cameras may be disposed on the vehicle respectively in front of the vehicle, behind the vehicle, and at both sides of a vehicle body. A mapping relationship between any point on a surface of the vehicle and a 2D point on the ground is calculated based on intrinsic parameter information of the four fisheye cameras and an overlapping area of images of every two fisheye cameras in the four fisheye cameras. Taking the fisheye camera as the first camera device has the following advantage. The fisheye camera has a relatively large angle of view; when four fisheye cameras are respectively disposed in four directions (each direction corresponds to 180 degrees) of the vehicle body, because the angle of view of the fisheye camera can reach 220° or 230°, there must be an overlapping area between two images obtained by every two adjacent fisheye cameras. In this case, a mapping relationship through which a point on a surface of a three-dimensional object in space is mapped to a 2D point on the ground is calculated based on the overlapping area.

Extrinsic parameter information of each first camera device in a pair of first camera devices in the first coordinate system is determined based on the mapping relationship between the first set point in the world coordinate system and the first set point in the image coordinate system.

In this embodiment, when the fisheye camera includes intrinsic camera parameter information such as a distortion value, a center point, and a focal length, a correspondence relationship between a point in space of the world coordinate system and a pixel coordinate of an image, that is, a correspondence relationship between a point in actual space (in this embodiment, a point on the fixed calibration plate) and a pixel coordinate of the point in an image captured by the camera device, is obtained based on the intrinsic parameter information of the camera device. In this way, a spatial pose of the first camera device in the world coordinate system is calculated by identifying a corner point in the fixed calibration plate by using the first camera device.

For example, by establishing world calibration coordinate systems respectively for positions of four camera modules on the vehicle body, distance information of a corner point at an upper left corner of each group of checkerboards in a calibration coordinate system is obtained. For example, a spatial position distance, in a corresponding calibration coordinate system, of a corner point at the upper left corner of each checkerboard corresponding to each camera device in the plurality of camera devices is measured by using a laser level and a measuring tape. The first extrinsic parameter information of the first camera device can be obtained when a distance from each first camera device to the first set point in the corresponding calibration plate in the world coordinate system, the intrinsic parameter information of the first camera device, and the mapping relationship between the first set point in the world coordinate system and the first set point in the image coordinate system are obtained. In this case, the first coordinate system is a camera coordinate system with the first camera device as an origin point. According to this embodiment, four fisheye cameras are calibrated at the same time by using the fixed calibration plate disposed on the ground, thereby improving a calibration speed of the camera device.

Optionally, the determining the first extrinsic parameter information of the second camera device in the first coordinate system based on the second image and the intrinsic parameter information of the second camera device in the foregoing embodiment includes: determining a mapping relationship between a second set point in the mobile calibration plate in the world coordinate system and the second set point in an image coordinate system corresponding to the second image based on the second image and the intrinsic parameter information of the second camera device.

Optionally, the second set point may be a corner point in the mobile calibration plate. For example, it may be a corner point located at an upper left corner of the mobile calibration plate.

The first extrinsic parameter information of the camera device in the first coordinate system is determined based on the mapping relationship between the second set point in the world coordinate system and the second set point in the image coordinate system.

It can be learned from this embodiment that, at least eight narrow-angle camera devices are calibrated. For example, when the mobile carrier is a vehicle, eight narrow-angle cameras are respectively disposed at the front of the vehicle, at the rear of the vehicle, near a left front door, near a right front door, near a left rear wheel, near a right rear wheel, at a left corner of the front of the vehicle, and at a right corner of the front of the vehicle. According to corresponding wall checkerboards within visible ranges of the eight narrow-angle cameras, a corner point in the checkerboard is identified, so as to extract a pixel coordinate. An ideal coordinate of the corner point is calculated based on the pixel coordinate of the corner point in the captured image and a calculation relationship, wherein the calculation relationship includes a distance from the camera device to a corner point on the mobile calibration plate corresponding to the image (for example, the distance is determined through actual measurement) and the intrinsic parameter information of the camera device, and the ideal coordinate indicates a pixel coordinate obtained when there is no offset in the pose of the camera device.

Specifically, the following can be included: determining an actual image height of an corner point in the captured image based on the pixel coordinate of the corner point; calculating an ideal image height of the corner point based on the actual image height of the corner point and the calculation relationship; determining the ideal coordinate of the corner point based on the ideal image height of the corner point; and determining the pose information of the camera device based on a relationship between the pixel coordinate of the corner point in the image and the ideal coordinate. According to this embodiment, extrinsic parameter calibration is performed on a plurality of camera devices at the same time, thereby improving efficiency of performing extrinsic parameter calibration on a plurality of ordinary cameras disposed on the mobile carrier such as a vehicle, so as to implement a technical effect of mass-production calibration.

On the basis of the foregoing embodiment shown in FIG. 6, step S022 may include:

determining a conversion parameter based on a positional relationship between the origin point of the first coordinate system and the origin point of the second coordinate system; and

translating and rotating the first extrinsic parameter information based on the conversion parameter, to obtain the target extrinsic parameter information of the camera device in the second coordinate system.

Optionally, for a camera device, the first coordinate system may be a device coordinate system with the camera device as an origin point. In this coordinate system, a direction to which the camera points is an x-axis, a leftward direction perpendicular to the x-axis is a y-axis, and an upward direction perpendicular to the x-axis is a z-axis. To be specific, when a coordinate system is determined, an origin point of the coordinate system is known. When the second coordinate system is a coordinate system that takes a point at which the camera device is vertical to the ground as an origin point, the conversion parameter merely includes distance information in a z-axis direction in the world coordinate system. Certainly, when the origin point of the second coordinate system is another position, the conversion parameter may further include distance information on the x-axis and/or the y-axis.

The target extrinsic parameter information of the camera device in the second coordinate system can be obtained by translating and rotating the first extrinsic parameter information based on the conversion parameter. Therefore, according to this embodiment, not only extrinsic parameter information is quickly obtained, but also the extrinsic parameter information of all camera devices is unified into a same coordinate system through coordinate system transformation. In this way, processing of the entire mobile carrier is facilitated, and an application scope and scenarios of this embodiment are increased.

Any extrinsic parameter calibration method for multiple camera devices provided in the embodiments of the present disclosure can be implemented by any suitable device having a data processing capability, including but not limited to a terminal device and a server.

Exemplary Electronic Device

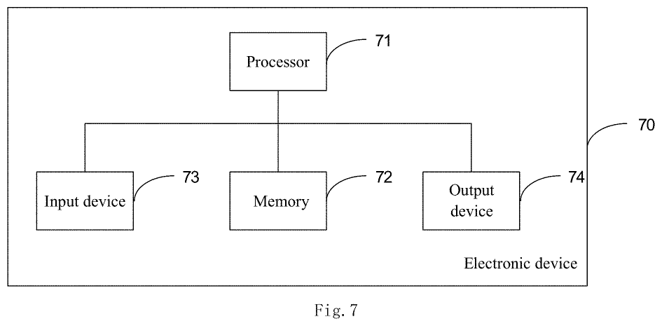

FIG. 7 shows a block diagram of an electronic device according to an embodiment of the present disclosure. As shown in FIG. 7, an electronic device 70 includes at least one processor 71 and at least one memory 72.

Each processor 71 may be a central processing unit (CPU) or another form of processing unit having a data processing capability and/or an instruction execution capability, and can control another component in the electronic device 70 to perform a desired function.

The memory 72 can include one or more computer program products. The computer program product can include various forms of computer readable storage media, such as a volatile memory and/or a non-volatile memory. The volatile memory may include, for example, a random access memory (RAM) and/or a cache. The nonvolatile memory may include, for example, a read-only memory (ROM), a hard disk, and a flash memory.

One or more computer program instructions can be stored on the computer readable storage medium. The program instructions can be executed by the processor 71, so as to implement the extrinsic parameter calibration method for multiple camera devices according to various embodiments of the present disclosure that are described above and/or other desired functions. Other information such as an input signal, a signal component, a noise component, and other contents may also be stored in the computer-readable storage medium.

In an example, the electronic device 70 may further include an input device 73 and an output device 74. These components are connected with each other through a bus system and/or other forms of connection mechanism (not shown).

Optionally, the input device 73 may be a microphone or a microphone array for capturing an input signal of a sound source. When the electronic device is a stand-alone device, the input device 73 may be a communication network connector for receiving the collected input signal.

Optionally, the input device 73 may further include, for example, a keyboard and a mouse. The output device 74 can output various information to the outside, including determined distance information, direction information, and the like. The output device 74 may include, for example, a display, a loudspeaker, a printer, a communication network, and a remote output device connected by the communication network.

Certainly, for simplicity, FIG. 7 shows only some of components in the electronic device 70 that are related to the present disclosure, and components such as a bus and an input/output interface are omitted. In addition, according to specific application situations, the electronic device 70 may further include any other appropriate components.

Exemplary Computer Program Product and Computer Readable Storage Medium

In addition to the foregoing methods and devices, the embodiments of the present disclosure may also relate to a computer program product, which includes computer program instructions. When the computer program instructions are run by a processor, the processor is enabled to perform the steps, of the extrinsic parameter calibration method for multiple camera devices according to the embodiments of the present disclosure, that are described in the “exemplary method” part of this specification.

The computer program product may be program codes, written with one or any combination of a plurality of programming languages, that are configured to perform the operations in the embodiments of the present disclosure. The programming languages include an object-oriented programming language such as Java or C++, and further include a conventional procedural programming language such as a “C” language or a similar programming language. The program codes can be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer readable storage medium, which stores computer program instructions. When the computer program instructions are run by a processor, the processor is enabled to performs the steps, of the extrinsic parameter calibration method for multiple camera devices according to the embodiments of the present disclosure, that are described in the “exemplary method” part of this specification.

The computer readable storage medium may be one readable medium or any combination of a plurality of readable media. The readable medium may be a readable signal medium or a readable storage medium. The readable storage medium may include, for example, but is not limited to an electricity, magnetism, light, electromagnetism, infrared ray, or semiconductor system, apparatus or device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or flash memory) or a flash memory, an optical fiber, a portable compact disk read-only memory (CD-ROM), an optical storage device, a magnetic storage device, or any suitable combination of the above.

Basic principles of the present disclosure are described above in combination with specific embodiments. However, it should be pointed out that the advantages, superiorities, and effects mentioned in the present disclosure are merely examples but not for limitation, and it cannot be considered that these advantages, superiorities, and effects are necessary for each embodiment of the present disclosure. In addition, specific details of the above disclosure are merely for examples and for ease of understanding, rather than limitations. The foregoing details do not limit that the present disclosure must be implemented by using the foregoing specific details.

The various embodiments in this specification are all described in a progressive way, and each embodiment focuses on a difference from other embodiments. For same or similar parts among the various embodiments, reference can be made to each other. The system embodiments basically correspond to the method embodiments, and thus are relatively simply described. For related parts, reference can be made to a part of the descriptions of the method embodiments.

The block diagrams of the equipment, the apparatus, the device, and the system involved in the present disclosure are merely exemplary examples and are not intended to require or imply that the equipment, the apparatus, the device, and the system must be connected, arranged, and configured in the manners shown in the block diagrams. It is recognized by a person skilled in the art that, the equipment, the apparatus, the device, and the system can be connected, arranged, and configured in an arbitrary manner. The terms such as “include”, “contain”, and “have” are open terms that mean “including but not limited to”, and can be used interchangeably with “including but not limited to”. The terms “or” and “and” used herein refer to the term “and/or”, and can be used interchangeably with “and/or”, unless the context clearly indicates otherwise. The term “such as” used herein refers to the phrase “such as but not limited to”, and can be used interchangeably with “such as but not limited to”.

The method and the apparatus in the present disclosure can be implemented in many ways. For example, the method and the apparatus in the present disclosure can be implemented by software, hardware, firmware, or any combination of the software, the hardware, and the firmware. The foregoing sequence of the steps of the method is for illustration only, and the steps of the method in the present disclosure are not limited to the sequence specifically described above, unless otherwise specifically stated in any other manner. In addition, in some embodiments, the present disclosure may also be implemented as programs recorded in a recording medium. These programs include machine-readable instructions for implementing the method according to the present disclosure. Therefore, the present disclosure further relates to a recording medium storing a program for implementing the method according to the present disclosure.

It should be further pointed out that, various components or various steps in the apparatus, the device, and the method of the present disclosure can be disassembled and/or recombined. These disassembling and/or recombinations shall be regarded as equivalent solutions of the present disclosure.

The foregoing description about the disclosed aspects is provided, so that the present disclosure can be arrived at or carried out by any person skilled in the art. Various modifications to these aspects are very obvious to a person skilled in the art. Moreover, general principles defined herein can be applicable to other aspects without departing from the scope of the present disclosure. Therefore, the present disclosure is not intended to be limited to the aspect illustrated herein, but to the widest scope consistent with the principles and novel features disclosed herein.

The foregoing descriptions has been given for illustration and description. In addition, this description is not intended to limit the embodiments of the present disclosure to forms disclosed herein. Although a plurality of exemplary aspects and embodiments have been discussed above, a person skilled in the art may recognize certain variations, modifications, changes, additions, and sub-combinations thereof.

1. An extrinsic parameter calibration device for multiple camera devices, comprising:
a plurality of mobile calibration plates, configured to complete extrinsic parameter calibration on all the multiple camera devices on a mobile carrier that is disposed in a set space and that carries the multiple camera devices, wherein each mobile calibration plate is disposed on a slide rail, and the slide rail is disposed on a wall in the set space; and
a control device, configured to control each mobile calibration plate in the plurality of mobile calibration plates to slide along the slide rail corresponding to the mobile calibration plate.

2. The device according to claim 1, wherein the control device is further configured to control slide between a plurality of the slide rails that have a connection relationship, so as to control the mobile calibration plate to slide upward, downward, leftward, and rightward on a plane corresponding to the wall where the mobile calibration plate is located.

3. The device according to claim 2, wherein through controlling, by the control device, the mobile calibration plate to slide along the corresponding slide rail, at least one of the following moving modes can be implemented: set-unit movement, set-length movement, and continuous movement;
a regression button is provided on the control device; and
the control device is further configured to control the plurality of mobile calibration plates to be regressed to an initial position by using the regression button.

4. The device according to claim 1, wherein each mobile calibration plate is further provided with a locking device for locking a position of the mobile calibration plate when power is off.

5. The device according to claim 1, to wherein a size of the set space is set based on a size of the mobile carrier.

6. The device according to claim 5, wherein the device further comprises:
a limiting guide that is disposed on a ground of the set space, and is configured to limit a position of the mobile carrier in the set space.

7. An extrinsic parameter calibration method for multiple camera devices, the method comprising:
detecting entrance of a mobile carrier that carries of the multiple camera devices into a set space, wherein the set space comprises a plurality of mobile calibration plates;
controlling the plurality of mobile calibration plates to move to a position corresponding to each of the multiple camera devices; and
performing extrinsic parameter calibration on the multiple camera devices based on the plurality of mobile calibration plates.

8. The method according to claim 7, wherein the controlling the plurality of mobile calibration plates to move to a position corresponding to each of the multiple camera devices comprises:
controlling each of the plurality of mobile calibration plates to slide on at least one slide rail, to move the mobile calibration plate to the position corresponding to each of the multiple camera devices.

9. The method according to claim 7, wherein the method further comprises:
in response to completing the extrinsic parameter calibration on the multiple camera devices, automatically returning the plurality of mobile calibration plates to an initial position.

10-12. (canceled)

13. A computer readable storage medium, wherein the storage medium stores a computer program; and
when the computer program is executed an extrinsic parameter calibration method for multiple camera devices is implemented,
wherein the extrinsic parameter calibration method comprises:
detecting entrance of a mobile carrier that carries of the multiple camera devices into a set space, wherein the set space comprises a plurality of mobile calibration plates;
controlling the plurality of mobile calibration plates to move to a position corresponding to each of the multiple camera devices; and
performing extrinsic parameter calibration on the multiple camera devices based on the plurality of mobile calibration plates.

14. (canceled)

15. The computer readable storage medium according to claim 13, wherein the controlling the plurality of mobile calibration plates to move to a position corresponding to each of the multiple camera devices comprises:
controlling each of the plurality of mobile calibration plates to slide on at least one slide rail, to move the mobile calibration plate to the position corresponding to each of the multiple camera devices.

16. The computer readable storage medium according to claim 13, wherein the method further comprises:
in response to completing the extrinsic parameter calibration on the multiple camera devices, automatically returning the plurality of mobile calibration plates to an initial position.

17. The device according to claim 1, wherein the mobile calibration plate is a chess board plate.

18. The device according to claim 2, wherein a vertical slide rail of the slide rails is movably connected to a transverse slide rail of the slide rails which is horizontally disposed.

19. The device according to claim 6, wherein the device further comprises a plurality of fixed calibration plates, which are disposed on the ground of the set space and are disposed around the limiting guide in the set space.

20. The method according to claim 8, wherein the controlling each of the plurality of mobile calibration plates to slide on at least one slide rail comprises:
controlling each of the plurality of mobile calibration plates to slide on the plurality of slide rails according to at least one moving mode, wherein the at least one moving mode includes set-unit movement, set-length movement, and continuous movement.

21. The method according to claim 9, wherein the automatically returning the plurality of mobile calibration plates to the initial position comprises:
determining a moving distance of the mobile calibration plate in at least one direction based on a distance between a coordinate of a current position of the mobile calibration plate and a coordinate of the initial position; and returning the mobile calibration plate to the initial position based on the moving distance in at least one direction.
